(19) United States
(12) Patent Application Publication
(10) Pub. No.: US 2025/0244209 A1
(43) Pub. Date: Jul. 31, 2025

(54) CALIBRATION OF A SAMPLING DEVICE FOR AN ANALYTICAL DEVICE

(71) Applicant: Agilent Technologies, Inc., Santa Clara, CA (US)

(72) Inventors: Blasius Nocon, Rheinstetten (DE); Lothar Mitzlaff, Nufringen (DE); Thomas Ortmann, Straubenhardt/Ottenhausen (DE)

(21) Appl. No.: 19/040,758

(22) Filed: Jan. 29, 2025

(30) Foreign Application Priority Data
Jan. 30, 2024 (GB) 2401170.2

(51) Int. Cl. G01N 1/14; G01N 35/00

(52) U.S. Cl. CPC G01N 1/14; G01N 35/0099; G01N 2001/1436

(57) ABSTRACT

A sampling device for an analytical device includes an object handling device, in particular a robotic arm, configured for handling an object such as an analytical sample. A needle is fixedly coupled to the object handling device. A driving device, coupled to the object handling device, is configured for providing a driving force to the object handling device to drive the object handling device, such as in the vertical direction. A movable element is movably coupled to the object handling device, such that the movable element is at least partially movable with respect to the fixedly coupled needle. A holding element is configured for providing a holding force to the movable element, such that the holding force holds the movable element against the driving force. A control device is configured to increase the driving force until the driving force overcomes the holding force at a break-off region.

### CROSS-REFERENCE TO RELATED APPLICATIONS

The present application claims the benefit of United Kingdom Patent Application No. GB 2401170.2, filed on Jan. 30, 2024, which is incorporated herein by reference in its entirety.

### TECHNICAL FIELD

The present disclosure relates to a device, in particular a sampling device, for an analytical device. The device comprises an object handling device coupled to a driving device and a fixed needle. The device further comprises a movable element, held in place by a holding force, wherein the holding force can be overcome by a driving force at a break-off region. The present disclosure further relates to the analytical device, in particular a chromatography device such as a high-performance liquid chromatography (HPLC) device. The present disclosure further relates to a corresponding method.

### BACKGROUND

Analytical devices are provided for analyzing a sample, such as for carrying out a chromatographic separation of the sample.

For example, for liquid separation in a chromatography system, a mobile phase comprising a sample fluid (e.g. a chemical or biological mixture) with compounds to be separated is driven through a stationary phase (such as a chromatographic column packing), thus separating different compounds of the sample fluid which may then be identified.

The mobile phase, typically comprised of one or more solvents, is pumped under high-pressure typically through a chromatographic column containing packing medium (also referred to as packing material or stationary phase). As the sample is carried through the column by the liquid flow, the different compounds, each one having a different affinity to the packing medium, move through the column at different speeds. Those compounds having greater affinity for the stationary phase move more slowly through the column than those having less affinity, and this speed differential results in the compounds being separated from one another as they pass through the column. The stationary phase is subjected to a mechanical force generated in particular by a hydraulic pump that pumps the mobile phase usually from an upstream connection of the column to a downstream connection of the column. As a result of flow, depending on the physical properties of the stationary phase and the mobile phase, a relatively high-pressure drop is generated across the column.

The mobile phase with the separated compounds exits the column and passes through a detector, which registers and/or identifies the molecules, for example by spectrophotometric absorbance measurements. A two-dimensional plot of the detector measurements against elution time or volume, known as a chromatogram, may be made, and from the chromatogram the compounds may be identified. For each compound, the chromatogram displays a separate curve feature also designated as a “peak”.

In preparative chromatography systems, a liquid as the mobile phase is provided usually at a controlled flow rate (e.g. in the range of 1 mL/min to thousands of mL/min, e.g. in analytical scale preparative LC in the range of 1-5 mL/min and preparative scale in the range of 4-200 mL/min) and at pressure in the range of tens to hundreds bar, e.g. 20-600 bar.

In high performance liquid chromatography (HPLC), a liquid as the mobile phase has to be provided usually at a very controlled flow rate (e.g. in the range of microliters to milliliters per minute) and at high-pressure (typically 20-100 MPa, 200-1000 bar, and beyond up to currently 200 MPa, 2000 bar) at which compressibility of the liquid becomes noticeable.

In order to introduce a (fluidic) sample into such an analytical device, there is generally applied a robotic arm fixed to a sample needle. In this manner, a high degree of automation and accuracy may be achieved. For this purpose, however, a precise calibration has to be done to know exactly where the needle (fixed to the robotic arm) is located in a sampling space. Performing such a calibration in a cost-efficient and reliable manner may still be considered a challenge.

In the case of conventional solutions, the movement of the robotic arm, in particular a pusher device arranged around the needle, is detected by associated encoders. For this purpose, the necessary preparations, both mechanical and electrical, must be provided, which may lead to complexity and thus to additional costs, specifically since the costs/efforts for such a displacement measuring system may be quite high.

### SUMMARY

There may be a need to operate a (needle of a) sampling device for an analytical device in an efficient and reliable manner.

According to a first aspect, there is described a device, preferably a sampling device for an analytical device (e.g. an HPLC), the device comprising:
i) an object handling device, in particular a robotic arm, configured for handling an object to be handled, in particular a sample such as an analytical sample (to be analyzed in the analytical device).
ii) a needle (a sample accommodation volume), in particular a sample needle, fixedly coupled (not movable on its own, only movable indirectly by moving the object handling device) to the object handling device.
iii) a driving device (e.g. a motor such as an electromotor), coupled to the object handling device, for providing a driving force Z (in particular in the vertical direction, along the z-axis, to move the needle during sample uptake/injection) to the object handling device to drive the object handling device, in particular in the vertical direction (z).
iv) a movable element (e.g. a pusher device), movably coupled to the object handling device (movable relative to the object handling device), so that the movable element is at least partially movable with respect to the fixedly coupled needle (at the object handling device).
v) a holding element (e.g. a magnet) for providing a holding force H to the movable element (in place with respect to the object handling device), wherein the holding force H holds the movable element against the driving force Z (so that the movable element is held in place, when the object handling device is moved in the vertical direction, in particular pressed against the object).
vi) a control device (e.g. a processor, an integrated circuit, a control system, a hardware/software, a local and/or remote system, etc.), configured to increase the driving force Z (by means of the driving device) until the driving force Z overcomes the holding force H at a break-off region (in particular a break-off point) (in particular, the holding force H is overcome suddenly/abruptly at a specific point, see e.g. FIG. 6).

According to a second aspect, there is described a method, comprising:
i) providing a driving force (Z) to an object handling device with a fixedly coupled needle to drive the object handling device, in particular in the vertical direction (z).
ii) movably coupling a movable element to the object handling device, so that the movable element is at least partially movable with respect to the fixedly coupled needle.
iii) providing a holding force (H) to the movable element, wherein the holding force (H) holds the movable element against the driving force (Z).
iv) increasing the driving force (Z) until the driving force (Z) overcomes the holding force (H) at a break-off region.

According to a third aspect, there is described a sampler for an analytical device which comprises a device as described above.

According to a fourth aspect, there is described an analytical device, comprising: a device/sampler as described above, and an analytical domain, in particular a chromatographic domain, coupled to the device/sampler and configured to analyze a fluidic sample.

In the context of the present document, the term “analytical device” may in particular refer to a device suitable to perform an analysis of a sample. In an example, the analytical device is applied to analyze (characterize) a sample by sample separation (such as chromatography), which may be termed analysis domain in the following. In the context of the present document, the term “chromatography device” may in particular refer to an instrument suitable to perform a chromatographic analysis, preferably for analyzing a sample, such as for carrying out a chromatographic separation of the sample. Examples of a chromatography device may include a high performance liquid chromatography (HPLC) instrument or a gas chromatography (GC) instrument.

In the context of the present document, the term “movable element” may in particular denote a part/portion of the (sampling) device that may be movable with respect to the object handling device and, accordingly, also relative to the fixed needle. Preferably, the movable element is a passive element which is moved only indirectly by moving the object handling device (and does not comprise its own motor). In an embodiment, the movable element is realized as a pusher device which is generally movable with respect to a fixed needle (and independent of the fixed needle).

In the context of the present document, the term “driving device” may in particular refer to a device suitable to provide a driving force Z to the object handling device. In an example, the driving device may be configured to move a robotic arm in a sampling space. In particular, the driving device may be configured to move the robotic arm in the vertical direction (up and down). In a preferred embodiment, the driving force Z may be increased, when the object handling device (in particular a part of the movable element) is pressed against an object (preferably a part of the movable element is pressed against the surface). The driving device may for example comprise a motor such as an electric motor. Such a motor may be well established in the field of sampling devices.

In the context of the present document, the term “holding element” may in particular refer to an element/device configured to provide a holding force H to (a part of) the movable element, thereby holding the movable element in place (in the starting position). However, in a preferred embodiment, the holding element is configured such that only two states (bistable) may be possible: holding and not holding. In other words, the holding element may be configured to provide the holding force (against the driving force) until a specific moment, when the holding force is overcome (sudden switching of states). Such a mechanism may be established for example with a magnet.

In the context of the present document, the term “break-off region” may refer to the circumstance that the above described holding force may be overcome suddenly/abruptly, thereby precisely defining a break-off region or break-off point. As illustrated for example in FIGS. 5 and 6, the break-off region may be clearly visible at a specific moving distance of the (sampling) device. The break-off region may hereby be found between a sudden increase and a sudden decrease of the driving force Z (when overcoming the holding force).

According to an exemplary embodiment, the disclosure may be based on the idea that a (needle of a) sampling device for an analytical device may be operated (and calibrated) in an efficient and reliable manner, when the position of the needle (or another part of the sampling device) is determined based on a break-off region where a driving force applied to a robotic arm overcomes a holding force provided to a movable part of the robotic arm. Such a holding force may be implemented by a bistable holding element such as a magnet.

In an embodiment, for such a hysteresis detection, existing encoders of the vertical (needle) axis may be used to detect the movement of the movable element (e.g. a pusher). For this to be possible, it may be monitored when and at what point the movable element starts moving. As soon as a movement is detected, the distance traveled may be recorded using the encoder of the vertical axis. The detection of the beginning of the movement of the movable element may be realized with the break-off point, generated by an increased initial resistance in the design of the movable element, realized by the holding element. By using the described disclosure, there may be no more need for an additional encoder, e.g. for the movable element. Instead, the already existing encoders for the basic function may be used for calibration, thereby saving costs and efforts.

In other words, the driving device may be monitored (e.g. regarding an electric parameter) to determine a point in time of releasing a movable portion of the robotic arm relative to a fixed portion of the robotic arm. The described approach may be directly implemented in existing systems in a straightforward and easy manner.

### EXEMPLARY EMBODIMENTS

In the following, further embodiments of the disclosure are described. These apply to the device(s) as well as to the method and the use.

In an embodiment, the control device is configured to calibrate the needle and/or the object handling device based on the break-off region, in particular the break-off point. This may provide the advantage that a precise calibration can be performed “on-the-fly”, i.e. by a mere movement of the (robotic arm of the) sampling device towards an object (such as a sample container). As is illustrated in FIGS. 5 and 6, the break-off point (when the driving force overcomes the holding force) can be clearly identified, for example based on monitoring electric parameters of the driving device. The distance moved by the object handling device (and hence the fixed needle) can be directly derived, and based on the distance, the precise location of the needle in space may be calculated.

It may be of high importance in the context of (automated) sampling to determine the exact location of the needle. According to the present disclosure, the location may be determined by monitoring the break/tear-off behavior. Since the needle is firmly attached to the robotic arm, the position of the object handling device is then also determined.

The described approach may be further used to determine a position of an object, in particular the sample container, e.g. to calibrate sample container (rack) positions in a sampling space. The point, at which the curve suddenly rises after the (guiding structure of the movable element of the) sampling device has been placed on the sample container (see FIGS. 5 and 6 between 1) and 2) in the current-displacement diagram), corresponds to the relative height of the sample container.

In an embodiment, the calibration comprises determining a relative or absolute spatial position of the needle (and/or the object handling device and/or the movable element and/or the object), in particular wherein the spatial position corresponds to a start of a movement of the needle after the break-off region. This may provide the advantage that a precise determination of the desired spatial position may be enabled. After passing the break-off point (regarding the movable element), the needle starts moving. Depending on the set-up and the (already) available information, the position of the needle can be determined in a relative or an absolute manner, for example using the encoders already present at the analytical device.

In an embodiment, the control device is configured to monitor/measure an electric parameter, in particular an electric current, with respect to the driving force (Z) provided by the driving device. Thereby, the driving force may be monitored in a reliable and practicable manner. In particular, the monitoring may be performed automatically.

In an embodiment, the control device is configured to determine the break-off region based on the measurement of the electric parameter. As can be seen for example in FIGS. 5 and 6, an electric parameter such as the applied electric current (of an electric motor of the driving device) may lead to a very precise determination of the break-off point in an automated, cost-efficient and reliable manner.

In an embodiment, the device is configured to drive, in particular press, the object handling device and/or a part of the movable element (in particular the guiding structure) against a (mounting) surface (of an object) (thereby increasing the driving force). The object may hence serve as a resistance to build-up the driving force to the break-off point.

In an embodiment, the object is at least one of a sample container, a needle seat, a wash port, a further device associated with the analytical device. Thus, an object of the analytical device may be directly applied for the calibration. More specifically, a device such as container/seat/port may be used, to which (into which) the needle will be approached anyway.

In an embodiment, the holding element is configured to hold the movable element in a bistable status. In an embodiment, the holding element is configured to hold the movable element in either a stable or a metastable status. Hence, the holding element may be configured to provide the holding force as a resistance against the driving force only until a specific point (break-off point), where it is overcome by the driving force. Thus, the holding element may only provide two states: holding (attached) and not-holding (released).

In an embodiment, the holding element comprises at least one of: a magnet, a spring, a clicker, a suction cup, a Velcro tape, a friction fit, a (re-usable) adhesive. These elements may be seen as some examples of how the holding force (in particular the bistable status) may be realized. Accordingly, the holding element may be implemented in a straightforward manner, using cost-efficient established tools.

In an embodiment, the movable element comprises a pusher device, in particular to push-off a sample container after sample take-up from the sample container. Preferably, the movable element is not realized by an additional device, but by a device that is already present at the sampling device, thereby saving costs and efforts. A pusher device for example is an established element in the field of sampling. In an embodiment, the pusher device comprises a guiding structure (at least partially) around the needle. Hereby, the pusher device may comprise a plate-like element with an opening to guide/align the needle during movement (sample uptake). When the needle is drawn back, the pusher device prevents that the sample container (or another object) remains stuck to the needle. In a preferred embodiment, the pusher device is for this purpose movable with respect to the rest of the robotic arm (object handling device) and the needle. Accordingly, the pusher device may be highly suitable to serve as the movable element in the present context.

In an embodiment, the pusher device comprises a guiding structure, arranged at least partially around the needle, in particular wherein the pusher device comprises a pusher element with an opening through which the needle can be aligned. Such an established design of the pusher device may be highly suitable for the present context.

In an embodiment, the movable element is movably coupled to the object handling device by means of a flexible element, in particular a spring element, wherein the flexible element limits the movement of the movable element with respect to the object handling device. In an embodiment, the flexible element provides a re-setting force (S), to the movable element, that counteracts the driving force, in particular after the break-off region. Thus, the movable element can always be brought back automatically to its starting position, thereby enabling an efficient operation.

In an embodiment, the movable element is a passive device, in particular free of a motor. In the present context, the term “passive” may refer to a device/element that is (essentially) free of a motor and thus has no driving force on its own. In other words, the movable element may only be movable (with respect to the object handling device), when the object handling device itself is moved (by the driving device). Accordingly, the movement of the movable element may be dependent on the movement of the object handling device (and the needle). The above-described flexible element may nevertheless move back the movable element in an advantageous manner.

In an embodiment, the break-off region is located between a (sudden) increase and a (sudden) decrease of the driving force (Z). In an embodiment, the break-off region is located between a (sudden) increase and a (sudden) decrease of the electric parameter (current) applied by the driving device. The sudden decrease may be caused by the holding element to clearly and precisely pronounce the breaking region.

In an embodiment, the object handling device is configured to move the needle to at least one of a starting position, a sample container, a sample up-take position, a needle injection seat. Thus, important functionalities in the context of analytical devices may be directly fulfilled by the (sampling) device. Each of these applications may also serve as the object onto which the device is pressed.

In an embodiment, the sample container comprises at least one of: a vial, a sample bottle, a tube, an Eppendorf tube, a (micro) titer plate, a deep-well plate. In an example, the sample container may be any device suitable for directly or indirectly storing a (fluidic) sample.

In an embodiment, the object handling device is configured as a robotic arm, in particular wherein the driving device is arranged at an extremity of the robotic arm. Accordingly configured robotic arms are established in the field of sampling, so that a straightforward implementation may be enabled.

In an embodiment, the device is configured as at least one of a sampling device, in particular for sampling a fluidic sample from the sample container, a metering device, a pipetting device, an injecting device. Thus, the described disclosure may be directly applied for a plurality of technically and economically important purposes.

In an embodiment, the method further comprises: calibrating the needle (and/or the object handling device and/or the movable element and/or the sample container) based on the break-off region, in particular determining a relative or absolute spatial position of the needle based on the break-off region.

In an embodiment, providing the driving force (Z) further comprises: pressing the device (in particular a part of the movable element) against a surface, in particular a surface of at least one of a sample container, a needle seat, a wash port.

In an embodiment, the analytical device is configured as a sample separation device, in particular a fluidic chromatography device, more in particular a high-performance liquid chromatography (HPLC) device.

In one embodiment, the sample separation device further comprises: a mixing point, where a sample is injected into the solvent, wherein the fluid compartment (the analytical device) is arranged upstream or downstream of the mixing point.

In one embodiment, the sample separation device further comprises: a solvent mixing point, where at least two solvent portions may be mixed, wherein the fluid compartment (the analytical device) is arranged upstream or downstream of the solvent mixing point.

In one embodiment, the sample separation device further comprises: a solvent drive, configured to drive the solvent as a mobile phase, wherein the fluid compartment (the analytical device) is arranged upstream or downstream of the solvent drive.

It becomes aware from the embodiments described directly above, that there is a high design flexibility regarding where the fluid compartment can be located in the analytical device/sample separation device. Depending on the present circumstances and the applied measurement method, different locations may be specifically favorable.

In one embodiment, the chromatography device comprises a mobile phase (solvent) drive and a separating device, wherein the mobile phase drive is configured for driving a mobile phase through the separating device, and the separating device is configured for chromatographically separating compounds of a sample fluid in the mobile phase.

In one embodiment, the analytical device and/or the sample separation device comprises a liquid chromatography system, wherein the sample fluid is a sample liquid, the mobile phase is comprised of one or more liquid solvents, and the separating device is a chromatographic column configured for separating compounds of the sample dissolved in the mobile phase.

In one embodiment, the chromatography device is a fluidic chromatography device, in particular a high performance liquid chromatography, HPLC, device.

Embodiments of the present disclosure might be embodied based on most conventionally available HPLC systems, such as the Agilent 1220, 1260 and 1290 Infinity LC Series (provided by the applicant Agilent Technologies).

The separating device preferably comprises a chromatographic column providing the stationary phase. The column might be a glass, metal, ceramic or a composite material tube (e.g. with a diameter from 50 μm to 5 mm and a length of 1 cm to 1 m) or a microfluidic column (as disclosed e.g. in EP 1577012 A1 or the Agilent 1200 Series HPLC-Chip/MS System provided by the applicant Agilent Technologies). The individual components are retained by the stationary phase differently and separate from each other while they are propagating at different speeds through the column with the eluent. At the end of the column, they elute at least partly separated from each other. During the entire chromatography process the eluent might be also collected in a series of fractions. The stationary phase or adsorbent in column chromatography usually is a solid material. The most common stationary phase for column chromatography is silica gel, followed by alumina.

The mobile phase (or eluent) can be either a pure solvent or a mixture of different solvents. It can also contain additives, i.e. be a solution of the additives in a solvent or a mixture of solvents. It can be chosen e.g. to adjust the retention of the compounds of interest and/or the amount of mobile phase to run the chromatography. The mobile phase can also be chosen so that the different compounds can be separated effectively. The mobile phase might comprise an organic solvent like e.g. methanol or acetonitrile, often diluted with water. For gradient operation water and organic solvent are delivered in separate containers, from which the gradient pump delivers a programmed blend to the system. Other commonly used solvents may be isopropanol, tetrahydrofuran (THF), hexane, ethanol and/or any combination thereof or any combination of these with aforementioned solvents.

The sample fluid might comprise any type of process liquid, natural sample like juice, body fluids like plasma or it may be the result of a reaction like from a fermentation broth, bio reactor, digestion, or other type of sample preparation.

The fluid is preferably a liquid but may also be or comprise a gas and/or a supercritical fluid (as e.g. used in supercritical fluid chromatography—SFC—as disclosed e.g. in U.S. Pat. No. 4,982,597 A).

The pressure in the mobile phase might range from 2-200 MPa (20 to 2000 bar), in particular 10-150 MPa (100 to 1500 bar), and more particularly 50-130 MPa (500 to 1300 bar).

The HPLC system might further comprise a detector for detecting separated compounds of the sample fluid, a fractionating unit for outputting separated compounds of the sample fluid, or any combination thereof. Further details of HPLC systems are disclosed with respect to the aforementioned Agilent HPLC series, provided by the applicant Agilent Technologies.

In an exemplary embodiment, the present disclosure relates to a sampling arm (object handling device) having a sampling needle and a pusher (movable element), wherein the sampling needle is fixedly coupled with the sampling arm, and the pusher (partially) radially surrounds the needle. The pusher is movable relative to the sampling arm. In order to know the precise position of both, the sampling arm and the pusher (being movable relative to the sampling arm), typically, adequate sensors are applied. Purpose of the present disclosure may be seen in getting get rid of the sensor required for determining elongation/position of the pusher. In the present context, it is important to precisely know the position of pusher and sampling arm/needle in order to allow the needle to move down to the bottom of a sample vial to aspirate any remaining sample without hitting/damaging the needle on contact with the sample container.

In an exemplary embodiment, the pusher is movable relative to the sampling arm by means of a lever. A (permanent) magnet on the sampling arm either holds the lever in a fixed position or allows the lever to swivel (around its rotational point) thus moving the pusher relative to the arm/needle. The problem in precisely sensing position of the pusher or sampling arm comes from the elasticity of the system on contact of the pusher e.g. with the sample vial. Apparently, the elasticity of the system allows the sampling arm to slightly swivel rather than moving in Z-direction as intended. In other words, on contact with the vial, it is not clear when precisely the sampling arm together with the needle actually moves in Z-direction.

In an exemplary embodiment, the disclosure may overcome that problem by using the holding element (bistable element, lever mechanism, etc.) and monitoring the motor current applied for moving the sampling arm in Z-direction. During phase 1, the sampling arm moves in Z-direction substantially without requiring force. When the pusher abuts with the vial, the current increases significantly—during phase 2—until reach of a maximum point, when the force holding the lever is overcome and the lever then can start swiveling (thus allowing the pusher to move in Z-direction as in phases 3 and 4). This maximum point or turning point (break-off region) of the motor current at the end of phase 2 may be a clear indication that the sampling arm is now (actually) moving in Z-direction, thus allowing to precisely determine Z-position of the sampling arm/needle without requiring an extra sensor.

### BRIEF DESCRIPTION OF THE DRAWINGS

Other objects and many of the attendant advantages of embodiments of the present disclosure will be readily appreciated and become better understood by reference to the following more detailed description of embodiments in connection with the accompanying drawings. Features that are substantially or functionally equal or similar will be referred to by the same reference signs.

FIG. 1 illustrates an analytical device implemented as a liquid chromatography device with a sampling device, according to an exemplary embodiment.

FIG. 2 illustrates a detailed view of a sampler with a sampling device, according to an exemplary embodiment.

FIG. 3 illustrates a sampling device, according to an exemplary embodiment.

FIG. 4A illustrates in detail the sampling device at a certain position during an operation of the sampling device, according to an exemplary embodiment.

FIG. 4B illustrates in detail the sampling device at another position during an operation of the sampling device, according to an exemplary embodiment.

FIG. 4C illustrates in detail the sampling device at another position during an operation of the sampling device, according to an exemplary embodiment.

FIG. 4D illustrates in detail the sampling device at another position during an operation of the sampling device, according to an exemplary embodiment.

FIG. 5 schematically illustrates a break-off point, according to an exemplary embodiment.

FIG. 6 shows an actual measurement of the break-off point, according to an exemplary embodiment.

### DETAILED DESCRIPTION

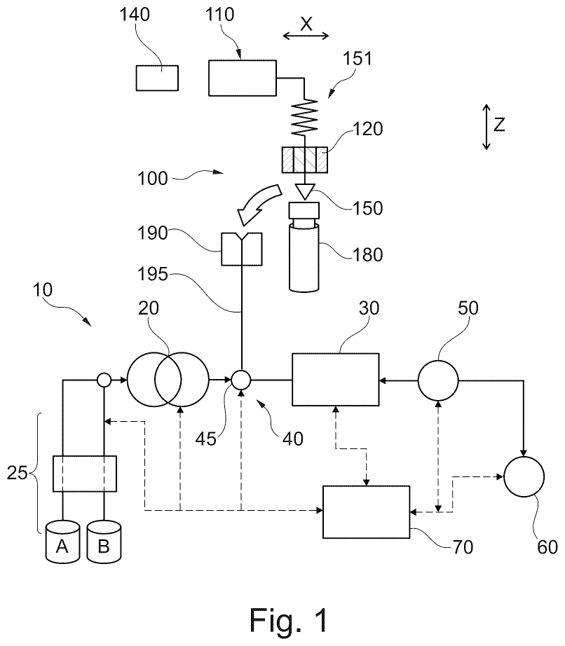

Referring now in greater detail to the drawings, FIG. 1 depicts a general schematic of an analytical device 10, implemented here as a high performance liquid chromatography (HPLC) device. A solvent drive 20 (such as a pump) receives a solvent as the mobile phase from a solvent supply 25. The solvent drive 20 drives the mobile phase through a separating device 30 (such as a chromatographic column), which can be seen here as the analytical domain of the device. A sample injector 40 (also referred to as sampler, sampling space, sample introduction apparatus, sample dispatcher, etc.) is provided between the solvent drive 20 and the separating device 30 in order to subject or add (often referred to as sample introduction) portions of one or more sample fluids into the flow of a mobile phase at a mixing point 45. The separating device 30 is adapted for separating compounds of the sample fluid, e.g. a liquid. A detector 50 is provided for detecting separated compounds of the sample fluid. A fractionating unit 60 can be provided for outputting separated compounds of sample fluid. In one embodiment, at least parts of the sample injector 40 and the fractionating unit 60 can be combined, e.g. in the sense that some common hardware is used as applied by both of the sample injector 40 and the fractionating unit 60.

The separating device 30 may comprise a stationary phase configured for separating compounds of the sample fluid. Alternatively, the separating device 30 may be based on a different separation principle (e.g. field flow fractionation).

While the mobile phase can comprise one solvent only, it may also be mixed of a plurality of solvents (solvent supply 25). Such mixing might be a low pressure mixing and provided upstream of the solvent drive 20, so that the solvent drive 20 already receives and pumps the mixed solvents as the mobile phase. Alternatively, the solvent drive 20 might comprise plural individual pumping units, with the pumping units each receiving and pumping a different solvent or mixture, so that the mixing of the mobile phase (as received by the separating device 30) occurs at high pressure and downstream of the mobile phase drive 20 (or as part thereof). The composition (mixture) of the mobile phase may be kept constant over time, the so-called isocratic mode, or varied over time, the so-called gradient mode.

A data processing device (control device) 70, which can be a conventional PC or workstation, might be coupled (as indicated by the dotted arrows) to one or more of the devices in the analytical device 10 in order to receive information and/or control operation.

The sample is injected into a needle seat 190 that is connected via a sample injection path 195 to the mixing point 45. Before being injected, the sample is stored in a sample container (vial) 180. In order to i) uptake the sample from the sample container 180, ii) move the sample towards the needle seat 190, and iii) inject the sample into the sample injection path 195, a sampling device 100 is applied. The sampling device 100 comprises an object/sample handling device 110, here a robotic arm, for handling/moving the sample. For this purpose, a sample needle 150 (eventually further coupled to a sample accommodation volume such as a sample loop 151) is fixedly coupled to the object handling device 110. By means of a driving device 140 such as a motor, the object handling device 100 can be moved within the sampling space in all three spatial directions (x, y, z).

Specifically, the driving device 140 is configured to provide a driving force Z to the object handling device 110 to drive the object handling device 110 in the vertical direction (along z-axis). Thereby, the sample needle 150 can be moved (vertically) in and out of the sample container 180. Further, the sample needle 150 can be moved (vertically) in and out of the needle seat 190.

In order to enable an efficient and reliable movement of the sample needle 150 out of the sample container 180, the sampling device 100 comprises a movable element 120, movably coupled to the object handling device 110, so that the movable element 120 is at least partially movable with respect to the fixedly coupled needle 150. The movable element 120 comprises for example a pusher device to push-off the sample container 180 after sample take-up from the sample container 180.

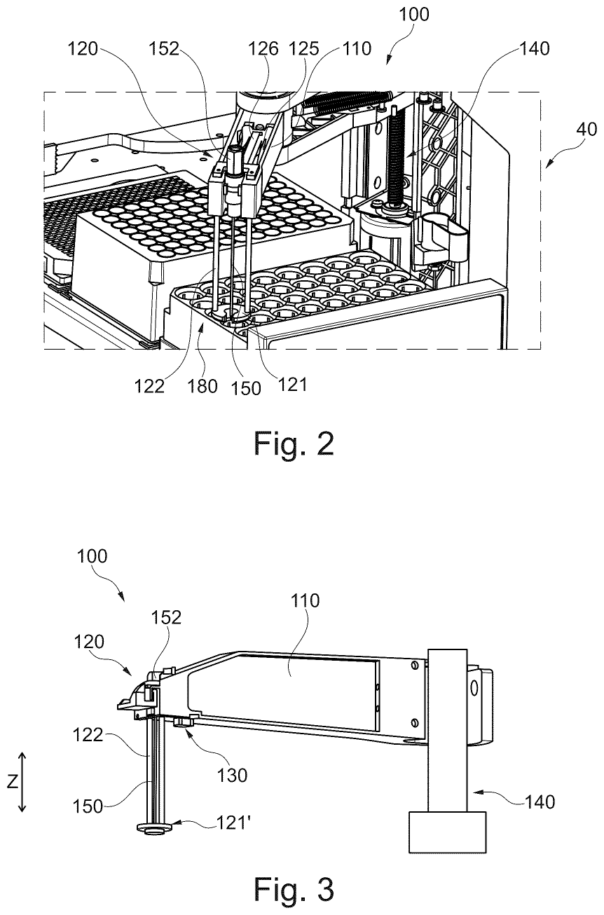

FIG. 2 illustrates a detailed view of a sampler 40 (sampling space) of/for the analytical device 10 with the sampling device 100, according to an exemplary embodiment. A plurality of sample containers 180 are arranged (organized in racks, sample container accommodation elements) in the sampling space 40 and fluidic sample is automatically aspirated using the sampling device 100. For this purpose, the sampling device 100 is freely movable within the sampling space 40. As already described for FIG. 1, the sampling device 100 comprises an object handling device 110 (here a robotic arm comprising two members) that is movable (in particular in vertical direction) by the driving device 140. At a first extremity, the object handling device 110 is coupled to the driving device 140. At a second extremity, the object handling device 110 comprises a needle fixing structure 152 to which sample needle 150 is fixedly (in a non-movable manner) coupled.

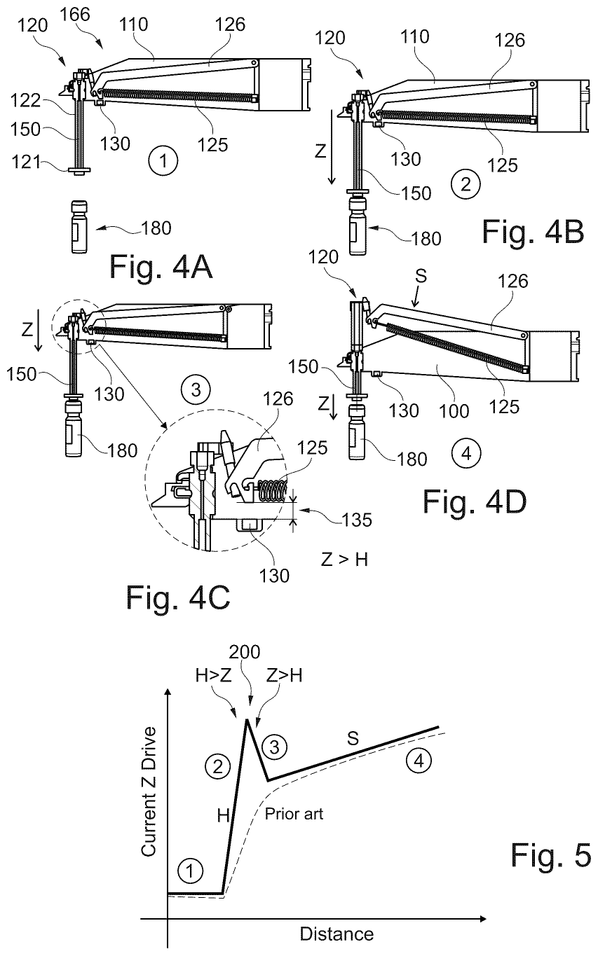

The movable element 120 comprises a lever element 126, a spring element 125, and a guiding structure 122. The lever element 126 is arranged in this example within the robotic arm of the object handling device 110. As will become clear in the context of FIGS. 4A to 4D, the spring element 125 enables a movement of the lever element 126 relative to the object handling device 110 (re-set force). The lever element 126 is further coupled to the guiding structure 122, so that the guiding structure 122 is also movable relative to the object handling device 110. The guiding structure 122 is arranged (next to but not in physical contact with) in parallel to the sample needle 150. The guiding structure 122 further comprises a (circular) plate with an opening 121 (pusher element). When moving the movable element 120 relative to the object handling device 110 (with the fixed sample needle 150), the sample needle 150 can be guided (in the vertical direction) through the opening 121.

In this configuration, the movable element 120 serves as a so-called pusher-device that pushes off a sample container 180, when moving the sample needle 150 out of the sample container 180.

FIG. 3 illustrates a side view of a sampling device 100, according to an exemplary embodiment. The sampling device 100 is configured in a comparable manner as described for FIGS. 1 and 2. Further, in this side view, a holding element 130 is visible, arranged at the bottom of the object handling device 110 in proximity to the sample needle 150. The holding element 130 holds the movable element 120 in place with respect to the object handling device 110 by a holding force H. In this example, the holding element 130 comprises a magnet, but many other implementations are possible (see above). The holding element 130 is configured to hold the movable element 120 in a bistable status (either a stable or a metastable status) by the holding force H.

When the object handling device 110 is moved (by the driving device 140) in the vertical direction onto a surface (in particular the upper surface of a sample container 180), and pressed on the surface, the movable element 120 (being a passive device) will be moved by the pressing force (actually a part of the movable element 120 (the pusher element of the guiding structure 122) is pressed onto the surface). However, this movement will be prevented by the holding element 130 until the holding force H is overcome by an increasing (driving) force Z in the vertical direction.

FIGS. 4A to 4D illustrate in detail an operation of the sampling device 100, according to exemplary embodiments.

FIG. 4A shows a sampling device 100 as described for FIG. 3 placed above a sample container 180. Further, it is illustrated that the lever element 126 of the movable element 120 is arranged (essentially) parallel to the robotic arm 110. The lever element 126 is coupled to the guiding structure 122 which is responsible for the actual push-off functionality. It can be seen that pressing the guiding structure 122 onto the upper main surface of the sample container 180 would move up (in the vertical direction) the guiding structure 122 together with the lever element 126. Since the lever element 126 is coupled with a spring element 125 to the object handling device 110, the movable element 120 will move back to its original position, when the pressure on the sample container 180 will decrease/stop.

FIG. 4B: the driving device 140 now moves the object handling device 110 with the driving force Z in the vertical direction z down towards the sample container 180. Yet, the holding element 130 holds the movable element 120 in place, since the holding force H is larger than the driving force Z. Thus, the movable element 120 is not moving and the pressure increases.

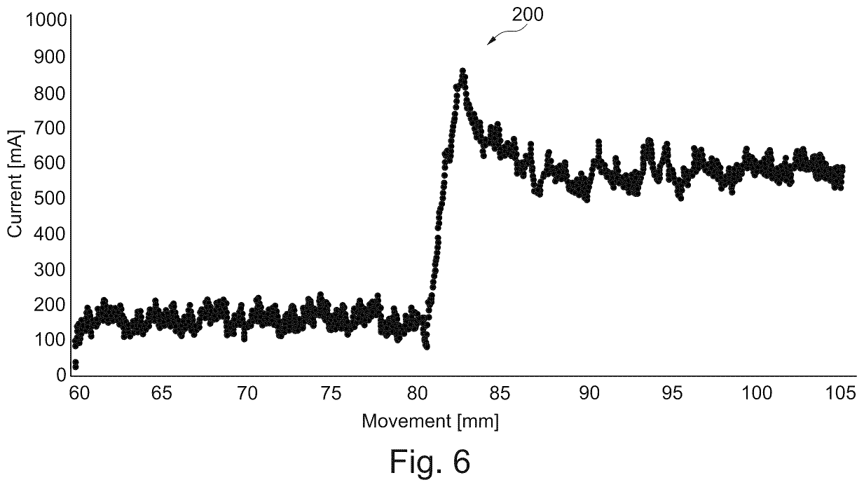

FIG. 4C: the driving force Z is now increased, and it can be seen in the detailed view that the driving force Z overcomes the holding force H: the movable element 120 is moved away from the holding element 130. As illustrated below in FIGS. 5 and 6, this break-off happens suddenly at a specific driving force, measurable by the electric current applied by the driving device 140.

FIG. 4D: after the break-off point, the sampling device 100 functions as described above: the sample needle 150 is guided through the opening 121 of the movable element 120 (and eventually into the sample container 180 for sample uptake). The movable element 120 is moved relative to the object handling device 110 and the sample needle 150: the guiding structure 122 is pressed upwards together with the coupled lever element 126 (swiveling). In absence of the driving force Z, the re-set force S (by means of the spring element 125) will move the movable element 120 back to its original position.

In other words, it is shown that a magnet 130 (or another initial resistance) is used to generate a hysteresis, which locks/holds the pusher arm (lever) 120/126 and only releases it as soon as a defined force Z in the z direction is reached. The current of the axis drive 140 is monitored to determine the point in time, respectively the current z-position, on releasing of the flexible/releasable portion 120 from the rigid arm portion 110.

FIG. 5 schematically illustrates a break-off point/region 200, according to an exemplary embodiment. The x-axis shows the distance (e.g. in mm) moved by the needle 150 fixed to the object handling device 110, while the y-axis shows the electric current applied by the driving device 140 to move the object handling device 110 in the z-direction.
Part 1) of the curve corresponds to FIG. 4A: the needle 150 is moved towards the sample container 180.
Part 2) of the curve corresponds to FIG. 4B: the object handling device 110 is pressed onto the sample container 180. Yet, the holding force H of the holding element 130 is larger than the driving force Z, so that the movable element 120 is held in place. The driving force Z is now increased, visible by the sudden increase of applied electric current. At the break-off point 200, the driving force Z suddenly overcomes the holding force H.
Part 3) of the curve corresponds to FIG. 4C: the movable element 120 is released from the holding element 130. The driving force Z (and the applied electric current) are suddenly decreased.
Part 4) of the curve corresponds to FIG. 4D: the spring element 125 provides the re-set force S to bring the movable element 120 back into its original position. In order to overcome the re-set force S, the driving force Z is slightly increased.

FIG. 6 shows an actual measurement of the break-off point 200, according to an exemplary embodiment. This diagram is comparable to the one described for FIG. 5, yet a real measurement is shown in FIG. 6. It can be seen that a clearly definable break-off point 200 can be identified. Based on this highly precise measurement of the distance moved by the needle (fixed to the object handling device), a calibration can be performed. For example, a control device 70 is configured to calibrate the needle 150 and/or the object handling device 110 based on the identified break-off region 200. The calibration can further comprise determining a relative or absolute spatial position of the needle 150 (wherein the spatial position corresponds to a start of a movement of the needle 150 after the break-off region 200).

### REFERENCE SIGNS

10 Analytical device
20 Solvent drive
25 Solvent supply
30 Separating device
40 Sample injector
45 Mixing point
50 Detector
60 Fractionating unit
70 Data processing device, control device
100 Device, sampling device
110 Object handling device
120 Movable element, pusher device
121 Opening
122 Guiding structure
125 Spring element
126 Lever element
130 Holding element
140 Driving device, motor
150 Needle
151 Sample loop
152 Needle fixing structure
180 Sample container, vial
190 Needle seat
195 Sample injection path
200 Break-off point
Z Driving force
H Holding force
S Re-set force

1. A sampling device for an analytical device, the sampling device comprising:
an object handling device configured for handling an object;
a needle fixedly coupled to the object handling device;
a driving device coupled to the object handling device and configured to provide a driving force to the object handling device to drive the object handling device in at least a vertical direction;
a movable element movably coupled to the object handling device, wherein the movable element is at least partially movable with respect to the needle;
a holding element configured to provide a holding force to the movable element, wherein the holding force holds the movable element against the driving force; and
a control device configured to increase the driving force until the driving force overcomes the holding force at a break-off region.

2. The sampling device according to claim 1, wherein the control device is configured to calibrate the needle and/or the object handling device and/or the movable element based on the break-off region.

3. The sampling device according to claim 2, comprising one of:
wherein the calibration comprises determining a spatial position of the needle;
wherein the calibration comprises determining a relative or absolute spatial position of the needle, and the spatial position corresponds to a start of a movement of the needle after the break-off region.

4. The sampling device according to claim 1, wherein the control device is configured to measure an electric parameter with respect to the driving force provided by the driving device.

5. The sampling device according to claim 4, wherein the control device is configured to determine the break-off region based on the measurement of the electric parameter.

6. The sampling device according to claim 1, comprising at least one of:
wherein the sampling device is configured to drive the object handling device against a surface of the object, thereby increasing the driving force;
wherein the sampling device is configured to drive a part of the movable element against a surface of the object, thereby increasing the driving force;
wherein the object comprises at least one of: a sample container; a needle seat; a wash port.

7. The sampling device according to claim 1,
wherein the holding element is configured to hold the movable element in a bistable status; and/or
wherein the holding element is configured to hold the movable element in either a stable or a metastable status.

8. The sampling device according to claim 1, wherein the holding element comprises at least one of: a magnet; a spring; a clicker; a suction cup; a Velcro tape; a friction fit; a re-usable adhesive.

9. The sampling device according to claim 1, wherein the object is a sample container, and the movable element comprises a pusher device configured to push off of the sample container after sample take-up from the sample container.

10. The sampling device according to claim 9, comprising one of:
wherein the pusher device comprises a guiding structure arranged at least partially around the needle;
wherein the pusher device comprises a guiding structure arranged at least partially around the needle, and a pusher element with an opening through which the needle can be aligned.

11. The sampling device according to claim 1, comprising one of:
wherein the movable element is movably coupled to the object handling device by a flexible element, and the flexible element is configured to limit the movement of the movable element with respect to the object handling device;
wherein the movable element is movably coupled to the object handling device by a flexible element, the flexible element is configured to limit the movement of the movable element with respect to the object handling device, and the flexible element comprises a spring element;
wherein the movable element is movably coupled to the object handling device by a flexible element, the flexible element is configured to limit the movement of the movable element with respect to the object handling device, and the flexible element is configured to provide a re-setting force to the movable element that counteracts the driving force after the break-off region.

12. The sampling device according to claim 1, wherein the movable element is a passive device.

13. The sampling device according to claim 1, comprising at least one of the following features:
wherein the break-off region is located between an increase and a decrease of the driving force;
wherein the break-off region is located between an increase and a decrease of an electric current applied by the driving device;
wherein the object handling device is configured to move the needle to at least one of: a starting position; a sample container; a sample up-take position; a needle injection seat;
wherein the object handling device comprises a robotic arm;
wherein the object handling device comprises a robotic arm and the driving device is arranged at an extremity of the robotic arm.

14. The sampling device according to claim 1, wherein the sampling device is configured as at least one of: a sampling device for sampling a fluidic sample from a sample container; a metering device; a pipetting device; an injecting device.

15. A sampler for an analytical device, the sampler comprising:
the sampling device according to claim 1; and
a needle seat configured to receive the needle.

16. An analytical device, comprising:
the sampling device according to claim 1; and
an analytical domain coupled to the sampling device and configured to analyze a fluidic sample.

17. The analytical device according to claim 16, wherein the analytical device has a configuration selected from the group consisting of: a sample separation device; a fluidic chromatography device; a high-performance liquid chromatography device.

18. A method for operating a sampling device for an analytical device, the method comprising:
providing a driving force to an object handling device with a fixedly coupled needle to drive the object handling device in at least a vertical direction;
movably coupling a movable element to the object handling device, so that the movable element is at least partially movable with respect to the fixedly coupled needle;
providing a holding force to the movable element, wherein the holding force holds the movable element against the driving force; and
increasing the driving force until the driving force overcomes the holding force at a break-off region.

19. The method according to claim 18, comprising one of:
calibrating the needle based on the break-off region;
calibrating the needle by determining a spatial position of the needle based on the break-off region.

20. The method according to claim 18, wherein providing the driving force comprises one of:
pressing the object handling device against a mounting surface;
pressing the object handling device against a mounting surface, wherein the mounting surface comprises at least one of: a sample container; a needle seat; a wash port.
